(19) United States
(12) Patent Application Publication
(10) Pub. No.: US 2026/0293875 A1
(43) Pub. Date: Oct. 1, 2026

(54) PEST CONTROL DEVICE

(71) Applicant: Pestie, Inc., Lehi, UT (US)

(72) Inventors: Trevor Brad West, Mapleton, UT (US); Jacob John Berube, South Jordan, UT (US)

(21) Appl. No.: 19/578,580

(22) Filed: Mar. 25, 2026

Related U.S. Application Data
(60) Provisional application No. 63/777,973, filed on Mar. 26, 2025.

(51) Int. Cl. A01M 1/14; F21S 8/00; F21Y 103/10; F21Y 115/10

(52) U.S. Cl. CPC A01M 1/145; F21S 8/035; A01M 2200/012; F21Y 2103/10; F21Y 2115/10

(57) ABSTRACT

A pest control device may include at least one light-emitting diode (LED) light, the LED light having a wavelength of between 300 nm and 600 nm. A pest control device may include a controller configured to periodically cycle the LED light between on and off with a cycling frequency, the cycling frequency at least 40 Hz. A pest control device may include a pest collector.

### CROSS REFERENCE TO RELATED APPLICATIONS

This application claims priority to and the benefit of United States Provisional Patent Application No. 63/777,973, filed on Mar. 26, 2025, which is hereby incorporated by reference its entirety.

### BACKGROUND

Pest control systems are designed to attract and capture or eliminate pests. Pests may include any type of pest, including the common house fly. House flies may be undesirable at a particular location. For example, house flies may be irritating and/or carry and spread disease.

### BRIEF SUMMARY

In some aspects, the techniques described herein relate to a pest control device. The pest control device includes at least one light-emitting diode (LED) light. The LED light has a wavelength of between 350 nm and 460 nm. A controller is configured to periodically cycle the LED light between on and off with a cycling frequency. The cycling frequency is at least 40 Hz. A pest collector collects pests attracted to the LED light.

In some aspects, the techniques described herein relate to a method for pest control. A controller lights a light-emitting diode (LED) light for a light period. The LED light has a wavelength of between 300 nm and 600 nm. The controller cycles the LED light off for a dark period. The light period and the dark period combine to form a cycling frequency of at least 40 Hz.

In some aspects, the techniques described herein relate to a pest control device. The pest control device includes a base. A light strip is supported by the base. The light strip includes a plurality of light-emitting diode (LED) lights emitting light in an ultraviolet frequency. A microcontroller is configured to cycle the plurality of LED lights between on and off with a cycling frequency. The cycling frequency is at least 40 Hz with a duty cycle of approximately 75%. A pest collector collects pests attracted to the LED light. A shield is connected to the base.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1-1 is a representation of a perspective view of a front end of a pest control device, according to at least one embodiment of the present disclosure.

FIG. 1-2 is a representation of a perspective view of a back end of the pest control device of FIG. 1-1.

FIG. 2 is a representation of a light strip, according to at least one embodiment of the present disclosure.

FIG. 3 is a representation of a light strip, according to at least one embodiment of the present disclosure.

FIG. 4 is a representation of a light control waveform, according to at least one embodiment of the present disclosure.

FIG. 5 is a flowchart of a method for controlling pests, according to at least one embodiment of the present disclosure.

### DETAILED DESCRIPTION

This disclosure generally relates to devices, systems, and methods for pest control. A house, office, store, or other location may contain undesirable flies and other pests. These pests may carry disease, be irritating to people at the location, or otherwise undesirable. Many people may desire to reduce the presence of pests at the location. Typically, a pest removal system may include an attractant and a removal system. The attractant may attract the pest, and the removal system may capture, kill, or otherwise incapacitate the pest. Conventional attractants may be chemical, visual, or other type of attractant.

In accordance with at least one embodiment of the present disclosure, a pest control device may include a light that is flickered to attract a pest. As discussed in further detail herein, the light may have a wavelength that is ultraviolet or at the high end of the violet spectrum. Certain pests, including various species of flies, may perceive light in the ultraviolet spectrum. The ultraviolet light may attract the flies while remaining invisible or having low-visibility to humans. This may increase the efficacy of the pest control device to attract flies while remaining invisible or with a low visibility to humans, thereby reducing the impact or annoyance of the pest control device to a human.

The light may be flickered, or periodically cycled between on and off. Flickering the light has been shown to increase the attractive qualities of the light to flies and other pests. The light may be flickered with a cycling frequency. The cycling frequency may be a frequency that is invisible, imperceivable to a human, or with a low visibility, but visible or perceivable to a fly. For example, as discussed in further detail herein, the light may be cycled with a cycling frequency of at least or more than 60 Hz. In some examples, the light may be cycled with a cycling frequency of between 60 Hz and 120 Hz.

The light may be flickered with a duty cycle. The duty cycle may be a representation of the percentage that the light is on with respect to an entire flicker cycle. For example, the duty cycle of the flickering light may be approximately 75%. This may increase the attractive quality of the light. For example, the duty cycle may increase the average power or intensity of the light, thereby increasing the visibility of the light to the pest while maintaining the contrast introduced by the flickering.

As illustrated by the foregoing discussion, the present disclosure utilizes a variety of terms to describe features and advantages of the pest control device. Additional detail is now provided regarding the meaning of such terms. For example, as used herein, the term “pest” refers to an undesirable organism. In particular, the term “pest” can include insects. For example, an insect may include any insect, such as flies, mosquitos, bugs, beetles, ants, and so forth. As a specific, non-limiting example, a pest may include a black house fly, including various species commonly identified as black house flies that are found in households and other locations where people congregate. While specific examples discussed herein may refer to black house flies, it should be understood that the techniques of the present disclosure may be applied to attract and capture multiple different types of pests, including other insects, arthropods, arachnids, and so forth.

As used herein, power may refer to the power emitted by a light, expressed in watts. For visible light, power may refer to the perceived brightness of a light. In some examples, power may refer to the power of the light source where it emits from the light source. In some embodiments, the power may refer to the power of the light source after it passes through a translucent shield or barrier that is at least partially translucent or transparent to the wavelength of light emitted by the light source.

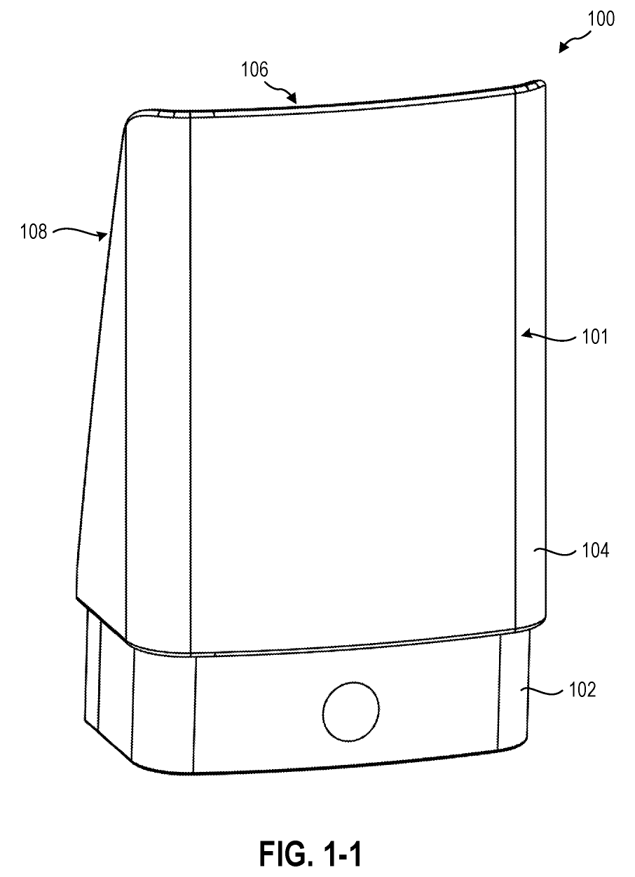

FIG. 1-1 is a perspective view of a front end 101 of a pest control device 100, according to at least one embodiment of the present disclosure. The front end of the pest control device 100 may be the end of the pest control device 100 that is visible to the user when the pest control device 100 is plugged into an electrical outlet installed in a wall. The pest control device 100 may include a base 102 and a shield 104. As discussed in further detail herein with respect, the base 102 may support a light strip. The light strip may include one or more lights that emit light in the ultraviolet or high-energy visible light (HEV light) spectrum.

When powered, the pest control device 100 may flicker the light source between on and off to attract pests. The light may be visible to the pests, and the pests may fly around the shield 104 to travel closer to the light. For example, the light may emit up past a top end 106 and/or the side edge 108 of the shield 104. In some examples, the shield 104 may be translucent or transparent to ultraviolet or HEV light, such that at least a portion of the light passes through the shield 104. The side edge 108 may be tapered from the base 102 to the top end 106. This may facilitate additional avenues for pests to pass into a collection area of the pest control device 100 while reducing the visibility of the collection area to the user when viewing the front end 101. While the side edge 108 is shown as a straight line taper, it should be understood that the shield 104 may have other shapes or mechanisms to allow light to exit and pests to enter the collection area, including jagged lines, curves, holes, and so forth.

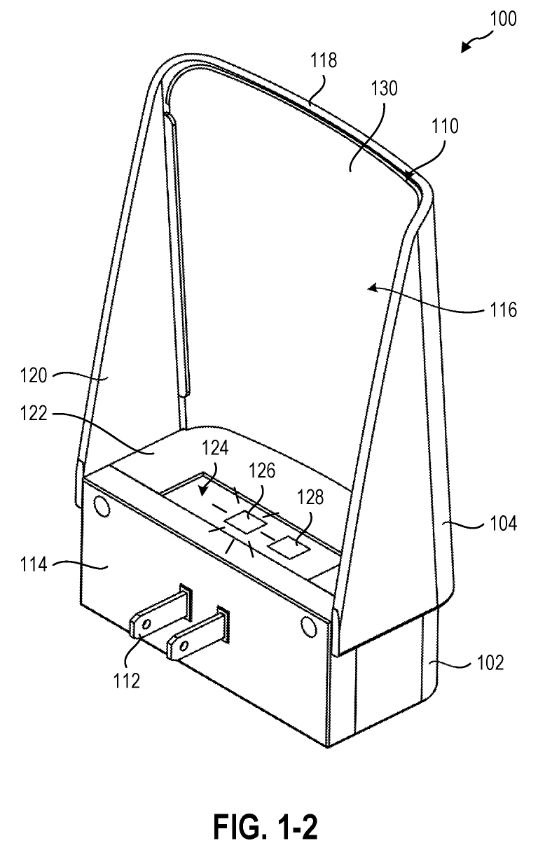

FIG. 1-2 is a representation of a perspective view of a back end 110 of the pest control device 100 of FIG. 1-1. The back end 110 may include a plug 112 extending from the base 102. The plug 112 may be configured to be plugged into a power outlet. For example, the plug 112 may be configured to be plugged into a standard 110 V or 120 V power outlet used in the United States. However, it should be understood that the plug 112 may be configured to be plugged into any outlet having any configuration, including A type outlets, B type outlets, C type outlets, D type outlets, E type outlets, F type outlets, G type outlets, I type outlets, J type outlets, K type outlets, L type outlets, M type outlets, N type outlets, O type outlets, universal outlets, any other outlets, and combinations thereof.

In the embodiment shown, when the plug 112 is plugged into a wall containing the power outlet, a back surface 114 of the base 102 may be flush with the back surface. For example, the wall in which the power outlet is installed may be flat, and the back surface 114 may be flat, or have a complementary surface to the wall. The plug 112 may be inserted into the plug, and the back surface 114 may be in contact with or offset from the wall by a small amount (e.g., less than 5 mm).

The shield may wrap around the 102 toward the back surface 114. This may form a collection area 116 formed at the back end 110 between a shield back surface 118, shield side surfaces 120, and an upper surface 122 of the base 102. When the pest control device 100 is plugged into a wall power outlet, the collection area 116 may be further formed by the wall. This may help to maintain the collection area 116 out of sight of the user.

The base 102 may support a light strip 124. The light strip 124 may include one or more light sources 126. The light source 126 may emit a light having a wavelength configured to attract pests toward the light source 126. For example, the light source 126 may have a wavelength that is in the ultraviolet spectrum. In some examples, the light source 126 may have a wavelength that is in the HEV light spectrum. In some embodiments, the wavelength may be in a range having an upper value, a lower value, or upper and lower values including any of 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 550 nm, 600 nm, or any value therebetween. For example, the wavelength may be greater than 300 nm. In another example, the wavelength may be less than 600 nm. In yet other examples, the wavelength may be any value in a range between 300 nm and 600 nm. In some embodiments, it may be critical that the wavelength is between 360 nm and 450 nm to attract pests toward the light source 126.

In some embodiments, the wavelength may be selected or controlled by utilizing a light source 126 that emits light only at the wavelength or within a wavelength range (such as an LED or other wavelength-controllable light source 126). In some embodiments, the wavelength may be selected or controlled based using a filter or other optical device located over the light source 126 such that light emitted from the light source 126 passes through the optical device prior to being emitted into the surrounding environment.

The light source 126 may be formed from any type of light. For example, the light source 126 may be formed from a light-emitting diode (LED). The LED light may be formed from any type of LED light, such as a miniature LED, a high-power LED, an organic LED (OLED), an AC-driven LED, a strip LED, any other type of LED, and combinations thereof. In some embodiments, the light source 126 may be a halogen light, an incandescent light, a chemical light, any other light source, and combinations thereof.

In accordance with at least one embodiment of the present disclosure, the light strip 124 may include multiple light sources 126 or multiple LED lights. For example, the light strip 124 may include 2, 3, 4, 5, 6, 7, 8, 9, 10, 15, 20, or more light sources 126. In some embodiments, each of the light sources 126 may emit light having the same wavelength. In some embodiments, two or more of the light sources 126 may emit light having different wavelengths. For example, as a specific, non-limiting example, the light strip 124 may include at least one first light source 126 having a first wavelength of between 350 and 380 nm, at least one second light source 126 having a second wavelength between 380 and 425 nm, and at least one third light source 126 having a third wavelength 425 nm and 460 nm. In some embodiments, the light strip 124 may include four first light sources having the first wavelength, two second light sources having the second wavelength, and two third light sources having the third wavelength. Combining multiple wavelengths of light may facilitate improved attraction of pests, particularly black house flies.

In accordance with at least one embodiment of the present disclosure, the light source 126 may have an average power. The average power may be the average power when cycling, or the power when averaged over the light period and the dark period. In some embodiments, the average power may be in a range having an upper value, a lower value, or upper and lower values including any of 1 W, 2 W, 3 W, 4 W, 5 W, 6 W, 7 W, 8 W, 9 W, 10 W, 12 W 14 W, 16 W, 18 W, 20 W, or any value therebetween. For example, the average brightness may be greater than 1 W. In another example, the average brightness may be less than 20 W. In yet other examples, the average brightness may be any value in a range between 1 W and 20 W. In some embodiments, it may be critical that the average brightness is 1 W and 20 W to be sufficiently bright to attract pests. In some embodiments, the average power may be the average power of a single light source 126. In some embodiments, the average power may be the average power of all of the light sources 126 on the light strip 124.

In accordance with at least one embodiment of the present disclosure, the shield 104 may be translucent or transparent. For example, the shield 104 may be translucent or transparent to light having the wavelength emitted by the light source 126. In some examples, the shield 104 may be translucent or transparent to light having the wavelengths emitted by the multiple light sources 126. A translucent or transparent shield 104 may allow at least a portion of the light from the light source 126 to pass through the shield 104. This may attract pests from additional directions than out of the open spaces between the shield 104 and the wall. In some embodiments, the translucency of the shield 104 may be 10%, 20%, 30%, 40%, 50%, 60%, 70%, 80%, 90%, 100% (e.g., transparent), or any value therebetween.

In accordance with at least one embodiment of the present disclosure, the pest control device 100 may include a controller 128 that may control cycling (also described herein as flickering) of the light source 126 on (e.g., lighting) and cycling the light source 126 off. In some embodiments, the controller 128 may periodically cycle the light source 126 through a light period in which the light source 126 is on, and a dark period in which the light source 126 is off. The controller 128 may cycle the light source 126 through the light period and the dark period with a cycling frequency. In some embodiments, the cycling frequency may be in a range having an upper value, a lower value, or upper and lower values including any of 40 Hz, 50 Hz, 60 Hz, 70 Hz, 80 Hz, 90 Hz, 100 Hz, 110 Hz, 120 Hz, 150 Hz, 180 Hz, 240 Hz, or any value therebetween. For example, the cycling frequency may be greater than 40 Hz. In another example, the cycling frequency may be less than 240 Hz. In yet other examples, the cycling frequency may be any value in a range between 40 Hz and 240 Hz. In some embodiments, it may be critical that the cycling frequency is between 40 Hz and 120 Hz to prevent the cycling from being visible to a person and to facilitate the attraction of pests to the light source 126.

The controller 128 that controls the cycling of the light source 126 may include any type of controller. For example, the controller 128 may include a microprocessor or microcontroller. n some examples, the controller 128 may include a pulse wave modulator.

In accordance with at least one embodiment of the present disclosure, the controller 128 may cycle each of the light sources 126 with the same cycling frequency. For example, as discussed herein, the light strip 124 may include multiple light sources 126. Indeed, the light strip 124 may include multiple light sources 126 having different wavelengths. The controller 128 may cycle each of the light sources 126 with the same cycling frequency. In some embodiments, different light sources 126 may be cycled with different cycling frequencies. For example, the first light source 126 having the first wavelength may be cycle with a first cycling frequency, and the second light source 126 having the second wavelength and/or the third light source 126 having the third wavelength may be cycled with a second cycling frequency different from the first. In some embodiments, different light sources 126 having the same wavelength may be cycled with different cycling frequencies.

In accordance with at least one embodiment of the present disclosure, the controller 128 may cycle the light source 126 with a duty cycle. The duty cycle may be a representation of the percentage of time that the light source 126 is in the light period (e.g., duration of light period divided by the sum of the light period and the dark period). In some embodiments, the duty cycle may be in a range having an upper value, a lower value, or upper and lower values including any of 1%, 5%, 10%, 15%, 20%, 30%, 40%, 50%, 55%, 60%, 65%, 70%, 75%, 80%, 85%, 90%, 95%, 99%, or any value therebetween. For example, the duty cycle may be greater than 1%. In another example, the duty cycle may be less than 99%. In yet other examples, the duty cycle may be any value in a range between 1% and 99%. In some embodiments, it may be critical that the duty cycle is between 50% and 75% to facilitate attraction of the pests to the light source.

Cycling the light source 126 having the particular cycling frequency may attract pests to the light strip 124 and the light source 126. In accordance with at least one embodiment of the present disclosure, the pest control device 100 may include a pest collector 130. The pest collector 130 may include any mechanism, device, or system that may collect the pests attracted to the light strip 124 and/or the light source 126. For example, the pest collector 130 may include one or more of an adhesive strip (e.g., a backing having glue or other sticky substance on one or both sides), an electric discharge insect control system (e.g., a bug zapper), a physical trap, any other pest collector, and combinations thereof.

In some embodiments, the pest collector 130 may be mounted to or at least partially supported by the shield 104. For example, the pest collector 130 may include a sheet that slides into holders such that the pest collector 130 is mounted on or at the shield back surface 118 of the shield 104. In some embodiments, the pest collector 130 may be mounted on or at least partially supported by the base 102. For example, a mount or other support may be located on the upper surface 122 of the base 102 and the pest collector 130 may be located on or supported by the mount or support on the 122 of the base 102.

When pests are attracted to the light source 126, the pests may be captured and/or exterminated by the pest collector 130. For example, the pests may be attracted to the light source 126. When the pests are attracted to the light source 126, the pests may enter the collection area 116. Given the generally erratic nature of the flight or travel of the pest, while in the collection area 116, the pest may wander or otherwise come into contact with the pest collector 130. The pest collector 130 may capture and/or exterminate the pests. In this manner, the pest control device 100 may facilitate attraction and collection or removal of pests proximate or within sight of the light emitted by the light source 126.

In accordance with at least one embodiment of the present disclosure, the pest control device 100 may include a power switch. The power switch may control power to the pest control device 100. For example, the power switch may allow the user to turn the light source 126 off without unplugging the pest control device 100 from the wall.

FIG. 2 is a representation of a light strip 224, according to at least one embodiment of the present disclosure. In the embodiment shown, the light strip 224 eight light sources (collectively 226). As discussed herein, the light sources 226 may emit light having a particular wavelength. In some embodiments, the eight light sources 226 may all emit light having the same wavelength. In some embodiments, two or more of the light sources 226 may emit light having different wavelengths.

As a specific, non-limiting example, the light sources 226 may include a first light source 226-1, a second light source 226-2, a third light source 226-3, a fourth light source 226-4, a fifth light source 226-5, a sixth light source 226-6, a seventh light source 226-7, and an eighth light source 226-8. The first light source 226-1, the second light source 226-2, the third light source 226-3, and the fourth light source 226-4 may have a first wavelength. The sixth light source 226-6 and the seventh light source 226-7 may have a second wavelength. The fifth light source 226-5 and the sixth light source 226-6 may have a third wavelength. The first wavelength may be in a range between 350 and 380 nm, the second wavelength may be in a range between 380 and 425 nm, and the third wavelength may be in a range between 425 and 460 nm.

While the embodiment illustrated in FIG. 2 includes eight light sources 226 having a specific arrangement, it should be understood that the light strip 224 may include any number of light sources having any arrangement. For example, the arrangement of light sources 226 having the first wavelength may be interspersed on the same row as light sources 226 having the second and/or the third wavelength. In some examples the light sources 226 may be arranged in a single row. In some examples, the light sources 226 may be arranged in three, four, or another amount of rows. In some examples, the light sources 226 may include any number of wavelengths and/or any number of light sources 226.

In some embodiments, each of the light sources 226 may have the same power. In some embodiments, different light sources 226 may have different powers. This may facilitate a mix of light emitted by the light sources 226 that is tailored to a particular application, such as targeting a particular pest and/or based on a particular environment, such as a particular room size or ambient lighting environment.

As discussed herein, the light sources 226 may be cycled on and off with a cycling frequency. In some embodiments, each of the light sources 226 may be cycled with the same cycling frequency. In some embodiments, different light sources 226 may be cycled with different cycling frequencies.

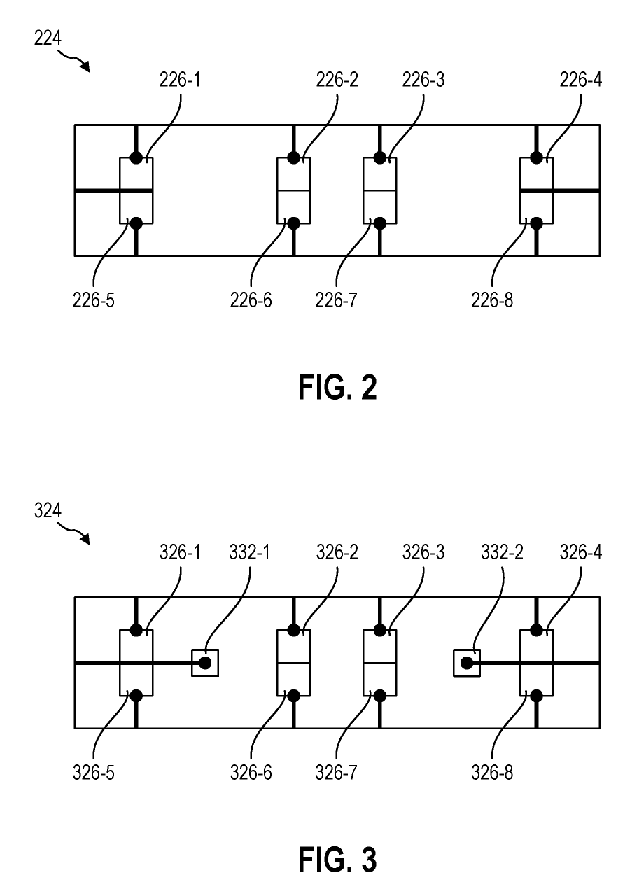

FIG. 3 is a representation of a light strip 324, according to at least one embodiment of the present disclosure. In the embodiment shown, the light strip 324 eight light sources (collectively 326). As discussed herein, the light sources 326 may emit light having a particular wavelength. In some embodiments, the eight light sources 326 may all emit light having the same wavelength. In some embodiments, two or more of the light sources 326 may emit light having different wavelengths.

As a specific, non-limiting example, the light sources 326 may include a first light source 326-1, a second light source 326-2, a third light source 326-3, a fourth light source 326-4, a fifth light source 326-5, a sixth light source 326-6, a seventh light source 326-7, and an eighth light source 326-8. The first light source 326-1, the second light source 326-2, the third light source 326-3, and the fourth light source 326-4 may have a first wavelength. The sixth light source 326-6 and the seventh light source 326-7 may have a second wavelength. The fifth light source 326-5 and the sixth light source 326-6 may have a third wavelength. The first wavelength may be in a range between 350 and 380 nm, the second wavelength may be in a range between 380 and 425 nm, and the third wavelength may be in a range between 425 and 460 nm.

In accordance with at least one embodiment of the present disclosure, the light strip 324 may include one or more visible lights (collectively 332). A visible light 332 may be a light that has a high visibility to a human, or a higher visibility than lights in the HEV light spectrum. For example, in the embodiment shown, the light strip 324 includes a first visible light 332-1 and a second visible light 332-2. The visible lights 332 may include one or more LED lights that emit light in the visible spectrum, or having wavelengths that are visible to the human eye. In some embodiments, the visible lights 332 may be decorative, or emit light that is generally pleasing to a user. In this manner, the visible lights 332 may contribute to the user generating a positive ambience or other decorations to the user’s home.

In some embodiments, the first visible light 332-1 and the second visible light 332-2 may be the same. For example, the first visible light 332-1 and the second visible light 332-2 may have the same color and/or brightness. In some embodiments, the first visible light 332-1 and the second visible light 332-2 may have different colors and/or brightness. In some embodiments, the visible lights 332 may have a variable color and/or brightness. This may further contribute to the decorative qualities of the light strip 324.

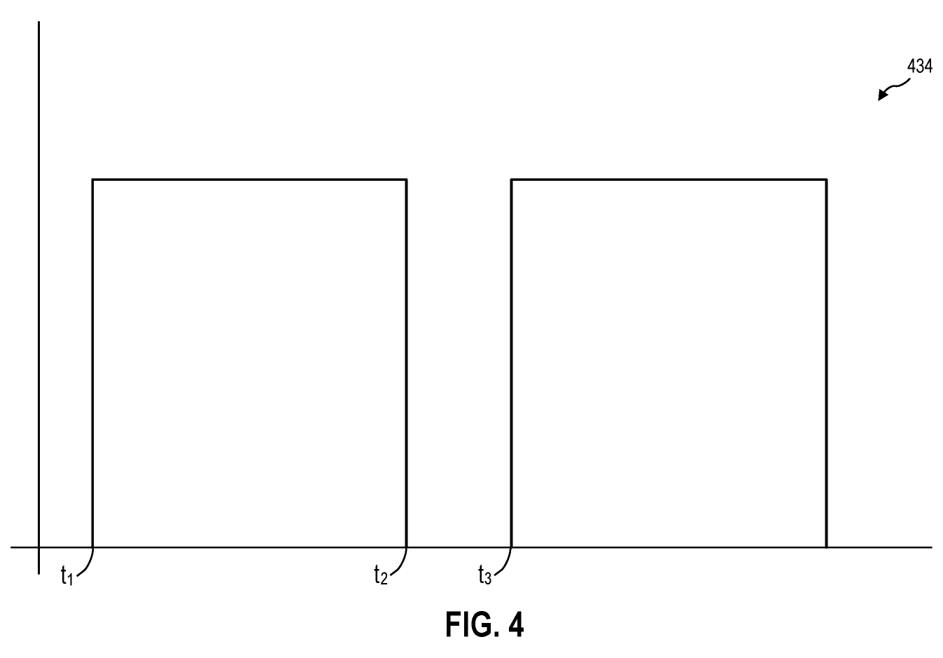

FIG. 4 is a representation of a light control waveform 434 having time on the x-axis (e.g., the horizontal axis) and power on the y-axis (e.g., the vertical axis), according to at least one embodiment of the present disclosure. The light control waveform 434 illustrated shows that the light is powered on at a first time t₁. The light is powered off at a second time t₂. The light is then powered on again at a third time t₃. The duration while the light is powered on (e.g., from t₁ to t₂) may be the light period, and the duration while the light is powered off (e.g., from t₂ to t₃) may be the dark period. The duration including the light period and the dark period (e.g., from t₁to t₃) may be a full cycle. The light control waveform 434 may be repeated indefinitely. In some embodiments, each of the full cycles may have the same duration. In some embodiments, the light control waveform 434 may be variable. For example, the light period, the dark period, and/or the full cycle may be variable from one cycle to the next. This may facilitate attraction of pests, including different pests to the pest control device.

The cycling frequency may be determined by the number of full cycles completed in one second. For example, for a cycling frequency of 60 Hz, the cycle from t₁ to t₃ may be repeated 60 times. In some embodiments, the duty cycle may be determined by the percentage of the light period with respect to the full cycle. For example, the duty cycle may be determined by dividing the time from t₁ to t₂ by the time from t₁to t₃.

While the light control waveform 434 of FIG. 4 is illustrated as being a square waveform, it should be understood that the techniques of the present disclosure may include light control waveforms 434 having different shapes. For example, the light control waveform 434 may include one or more of square, sine, sawtooth, ramp, triangular, pulse signal, exponential, any other waveform, and combinations thereof.

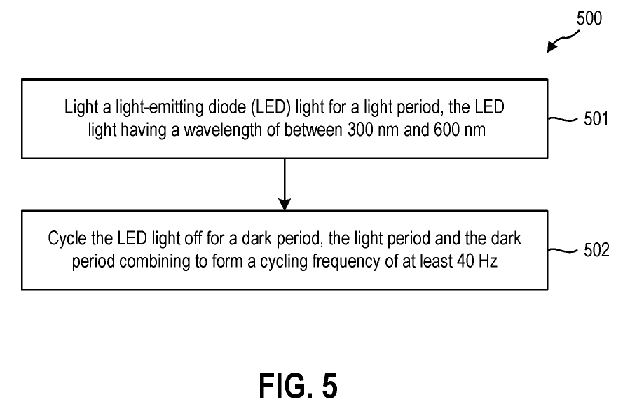

FIG. 5, the corresponding text, and the examples provide a number of different methods, systems, devices, and computer-readable media of the pest control device. In addition to the foregoing, one or more embodiments can also be described in terms of flowcharts comprising acts for accomplishing a particular result, as shown in FIG. 5. FIG. 5 may be performed with more or fewer acts. Further, the acts may be performed in differing orders. Additionally, the acts described herein may be repeated or performed in parallel with one another or parallel with different instances of the same or similar acts.

As mentioned, FIG. 5 illustrates a flowchart of a series of acts or a method 500 for pest control, according to at least one embodiment of the present disclosure. While FIG. 5 illustrates acts according to one embodiment, alternative embodiments may omit, add to, reorder, and/or modify any of the acts shown in FIG. 5. The acts of FIG. 5 can be performed as part of a method. Alternatively, a computer-readable medium can comprise instructions that, when executed by one or more processors, cause a computing device to perform the acts of FIG. 5. In some embodiments, a system can perform the acts of FIG. 5.

A controller of the pest control device may light an LED light for a light period at 501. The lights period may have a wavelength of between 300 nm and 600 nm. The controller may cycle the LED light off for a dark period at 502. The light period and the dark period may combine to form a cycling frequency of at least 40 Hz.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry, software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers’ specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A pest control device, comprising:
at least one light-emitting diode (LED) light, the LED light having a wavelength of between 300 nm and 600 nm;
a controller configured to periodically cycle the LED light between on and off with a cycling frequency, the cycling frequency at least 40 Hz; and
a pest collector.

2. The pest control device of claim 1, wherein the controller is configured to cycle the LED light with a duty cycle of between 50% and 75%.

3. The pest control device of claim 1, wherein an average power of the LED light is between 1 W and 20 W.

4. The pest control device of claim 1, wherein the pest collector includes an adhesive strip.

5. The pest control device of claim 1, wherein the controller includes a pulse wave modulator.

6. The pest control device of claim 1, wherein the LED light includes a plurality of LED lights.

7. The pest control device of claim 6, wherein at least two of the plurality of LED lights have a different wavelength.

8. The pest control device of claim 7, wherein a first LED light of the plurality of LED lights has a first wavelength of between 350 and 380 nm, a second LED light of the plurality of LED lights has a second wavelength of between 480 and 425 nm, and a third LED light of the plurality of LED lights has a third wavelength of between 425 and 460 nm.

9. The pest control device of claim 8, wherein the plurality of LED lights include four LED lights having the first wavelength, two LED lights having the second wavelength, and two LED lights having the third wavelength.

10. The pest control device of claim 6, wherein at least two of the plurality of LED lights have the same cycling frequency.

11. A method for pest control, the method comprising:
lighting a light-emitting diode (LED) light for a light period, the LED light having a wavelength of between 300 nm and 600 nm; and
cycling the LED light off for a dark period, the light period and the dark period combining to form a cycling frequency of at least 40 Hz.

12. The method of claim 11, wherein the cycling frequency has a duty cycle of approximately 75% light period.

13. The method of claim 11, wherein lighting the LED light includes lighting a plurality of LED lights and cycling the LED light off includes cycling the plurality of LED lights off.

14. The method of claim 13, wherein lighting the plurality of LED lights and cycling the plurality of LED lights off includes cycling all of the plurality of LED lights off with the same cycling frequency.

15. The method of claim 11, wherein, over the cycling period, the LED light has an average power of between 1 W and 20 W.

16. A pest control device, comprising:
a base;
a light strip supported by the base, the light strip including at least one light-emitting diode (LED) light emitting light in an ultraviolet frequency;
a microcontroller configured to cycle the plurality of LED lights between on and off with a cycling frequency, the cycling frequency at least 40 Hz with a duty cycle of approximately 75%;
a pest collector; and
a shield connected to the base.

17. The pest control device of claim 16, wherein the light strip further supports at least one visible light.

18. The pest control device of claim 16, further comprising:
a wall plug; and
a power switch configured to switch power on and off to the light strip and the microcontroller.

19. The pest control device of claim 16, wherein a first LED light of the plurality of LED lights has a first wavelength of between 350 and 380 nm, a second LED light of the plurality of LED lights has a second wavelength of between 380 and 425 nm, and a third LED light of the plurality of LED lights has a third wavelength of between 425 and 460 nm.

20. The pest control device of claim 16, wherein the pest collector includes an adhesive strip.
